(19) United States
(12) Patent Application Publication
(10) Pub. No.: US 2005/0086157 A1
(43) Pub. Date: Apr. 21, 2005

(54) Loan calculator

(76) Inventors: Marc Robeljo, Voorhees, NJ (US); Conrad Robeljo, Voorhees, NJ (US)

Correspondence Address: COZEN O'CONNOR, P.C., 1900 MARKET STREET, PHILADELPHIA, PA, 19103-3508, US

(21) Appl. No.: 10/715,808

(22) Filed: Nov. 17, 2003

Related U.S. Application Data
(60) Provisional application No. 60/513,129, filed on Oct. 21, 2003.

(51) Int. Cl. G06F 17/60

(52) U.S. Cl. 705/38

(57) ABSTRACT

A device and method for calculating loan factors based on answers to questions generated and displayed on a user input device.

This application claims the benefit of Provisional Application Ser. No. 60/513,129 filed on Oct. 21, 2003.

### BACKGROUND OF THE INVENTION

This invention relates to the field of computer devices and methods, and particularly to the calculation of loan data. The invention especially relates to hand-held computers and calculators.

Loan calculators used in spreadsheets and on internet web sites are well known. However, in spite of the prevalence of such loan calculator functionality in computers in general and through the internet web sites, there are many consumers who do not have the ability to use or operate such computers due to their complexity and the level of computer skills required, as well as the inconvenience of having to carry a computer, even a laptop, around. Furthermore, when a consumer is buying a car or home appliance, he or she does not usually carry a laptop computer or have access to a desktop computer, and so it is an object of this invention to provide a much simpler, more convenient, and easier to carry device which is dedicated to one function, i.e., loan calculation on the spot.

There is a need for a much simpler loan calculation method and device wherein any user, no matter how low of a level of computer skills he or she has, can provide some loan information and receive the remaining information.

### SUMMARY OF THE INVENTION

This need and others which will become apparent from the following disclosure are achieved by the present invention which comprises in one aspect a hand held calculator dedicated to calculating periodic payments on a loan comprising
a. means for selecting a type of loan;
b. means for selecting a cost of the item being purchased;
c. means for selecting any down payment amount;
d. means for selecting an interest rate;
e. loan period or number of periodic payments;
f. means for calculating and displaying or announcing by voice simulation the periodic payment based on the selected information.

Another aspect of the invention is a method of calculating loan factors comprising generating a series of questions, displaying the questions on a user device, receiving answers to the questions from a user, and calculating a loan factor based on the answers to the questions from the user.

The type of loan is preferably selectable by the user by responding to very simple questions, either on a display, a personal data assistant, or cell phone display, or voice simulated questions. The type of loan can be a home loan, auto loan or lease, equipment loan such as a television or other home appliance, for example. The loan period is usually requested, for example the device may ask-whether the period is in months or years and how many months or years. The interest rate is usually requested by the device, for example in units of percentage. Upon receipt from the user of the amount of the loan, the period and type of loan, and the interest rate, the device uses simple, well established algorithms to calculate and return to the user the remaining information, such as the monthly payment.

The method of the invention can be implemented on any hand-held sized device such as a calculator, a personal data assistant, an enhanced cell phone, and the like. The device can reside on the user device or it can reside on a web server.

### BRIEF DESCRIPTION OF THE DRAWINGS

FIG. 1 is illustrates flow chart of an embodiment of the invention including a question and answer routine to be displayed on the handheld calculator screen.

### DETAILED DESCRIPTION OF THE INVENTION AND THE PREFERRED EMBODIMENTS

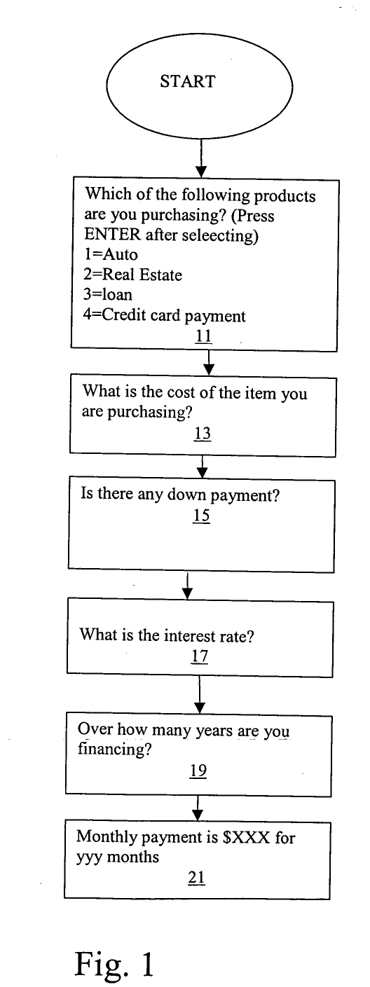

Referring first to FIG. 1, a flow chart illustrating an embodiment of the method of the invention is shown. Only the questions displayed by or voice simulated by the device are illustrated in FIG. 1. The answers are user options and are not shown in the drawing, but should be readily apparent. A screen is displayed 11 which comprises a first question, “what is the type of loan, 1=auto, 2=real estate, 3=loan, 4=credit card payment.” The user may respond with an answer such as “car loan.” The device then displays 13 a second question, “how much is the loan for.” The user may answer $20,500 and then press ENTER.” The device then asks 15 whether there is a down payment. The user may answer “no” and then press ENTER. The device may then asks 17 “what is the interest rate?” The user may then answer “5%” and then press ENTER. The device 19 then asks the period of the loan in months. The user may then answer “36 months” and then press ENTER. The device than calculates and displays 21 the monthly payment.

Other features adapted to car loans in particular may be employed, for example asking “is there a trade in or down payment,” and the like.

While the invention has been described and enabled in detail herein, various modifications, alterations, and alternative embodiments should become readily apparent to those skilled in this art without departing from the spirit and scope of the invention.

1. A handheld calculator device for calculating periodic payments on a loan comprising
a. means for selecting a type of loan;
b. means for selecting a cost of the item being purchased or a loan amount;
c. means for selecting a loan period or number of periodic payments;
d. means for selecting whether there is a down payment and if so, a down payment amount;
e. means for selecting an interest rate;
f. means for calculating the periodic payment based on the selected information.

2. The device of claim 1 wherein the type of loan is selected from the group consisting of home loan, automobile loan, automobile lease, bank loan, and credit card loan.

3. The device of claim 1 wherein the loan period is selected in units of months or years.

4. The device of claim 1 comprising a desktop computer, laptop computer, personal data assistant, web server, or cellular telephone device.

5. The device of claim 1 wherein a series of questions are displayed on a screen of a user's computer, personal data assistant, or cellular telephone device, the series of questions comprising
a. total interest paid over a period?;
b. the number of years of months during which payments will be due?;
c. the interest rate?;
d. the periodic payment in units of dollars and cents?;
wherein upon receiving answers to three of the questions, the fourth question is automatically answered and the automatic answer is displayed on the screen.

6. The device of claim 1 comprising voice simulation means and for receiving spoken responses and calculating payments based on the spoken responses.

7. A method of calculating loan factors comprising generating a series of questions, displaying the questions on a user device, receiving answers to the questions from a user, and calculating a loan factor based on the answers to the questions from the user.

8. The method of claim 7 wherein the loan factors are one or more selected from the group consisting of
a. type of loan;
b. whether payments are weekly, monthly, annual, or another type of period;
c. number of payments;
d. term of loan;
e. interest rate;
f. periodic payment in units of dollars and cents; and
g. total interest to be paid over the term.

9. The method of claim 7 comprising processing voice input information regarding answers to the questions and generating voice simulated responses.
